(19) United States
(12) Patent Application Publication
(10) Pub. No.: US 2004/0069694 A1
(43) Pub. Date: Apr. 15, 2004

(54) Fuel system including a water sensor, and a method of installing the water sensor in the fuel system

(76) Inventors: Paul A. Gamble, Peoria, IL (US); C. Brian Myer, Peoria, IL (US); Terry L. Miller, Morton, IL (US)

Correspondence Address: Michael B. McNeil, Liell & McNeil Attorneys PC, P.O. Box 2417, Bloomington, IN, 47402, US

(21) Appl. No.: 10/268,647

(22) Filed: Oct. 10, 2002

(51) Int. Cl. B01D 35/143

(52) U.S. Cl. 210/85; 210/86; 210/96.1; 210/299

(57) ABSTRACT

Often, within a fuel system, water is separated from fuel and collected in a water collection housing that includes a water sensor. The water sensor senses and alerts an operator when the water level rises to a point where it should be drained from the water collection housing. Installation of the water sensor may require drilling holes in the water collection housing. In the present invention, a water sensor is installed in a fuel system by positioning a first portion of the water sensor inside a water collection housing, exposing a second portion of the water sensor outside the water collection housing, and connecting the first portion and the second portion of the water sensor, at least in part, by positioning a third portion of the water sensor in a water drain assembly. The water drain assembly is positioned within a drain opening included within the water collection housing. Because the third portion of the water sensor is included in the water drain assembly and the water drain assembly is positioned within the drain opening, the water sensor can be installed without drilling holes through the water collection housing.

### TECHNICAL FIELD

The present invention relates generally to fuel systems, and more specifically to a method of installing a water sensor in the fuel system.

### BACKGROUND

In several diesel fuel systems today, particulates and other solids are removed from fuel, and water is separated from fuel prior to the fuel being injected into an engine. A common method for separating water from fuel and removing particulates and solids from fuel is to pass the fuel through a fuel filter positioned within a fuel filter assembly. Due to its specific gravity, as the fuel passes through the fuel filter, the water will separate from the fuel and will collect in the bottom of the fuel filter assembly. If the collected water is not periodically removed form the fuel filter assembly, the water will rise to a level where the water is mixing with the fuel flowing through the fuel filter. In order to prevent the mixing of the fuel with the water, an operator should periodically drain the water from the fuel filter assembly.

Over the years, engineers have developed methods of alerting an operator when the water level within the fuel filter assembly has reached an undesirable level and should be drained. For instance, some fuel filter assemblies, such as that shown in U.S. Pat. No. 6,083,381, issued to Connelly, et al. on Jul. 4, 2000, include a translucent housing, or a window, in order for the operator to view a float. Because the float has a density in which it floats in water but sinks in the fuel, the float will indicate the water level within the fuel filter assembly. When the water level is nearing contact with the fuel flowing through the fuel filter, the operator will drain the water from the fuel filter assembly. Although the translucent housing, or window, permits the operator to determine the water level within the fuel filter assembly, this method does not automatically alert the operator when the water level has risen to the undesirable level. Thus, in order to prevent mixing of the separated water with the fuel, the operator must diligently check the water level within the bowl.

There are also other methods of detecting and alerting the operator of the water level within the fuel filter assembly. For instance, an electric water sensor can sense when the water reaches the undesirable level and alert the operator. The water sensor is included on an electrical circuit with a visual or audio indicator which will alert the operator when the water sensor senses that the water has reached the undesirable level. The water sensor includes two electrical conductors, at least one of which is exposed at a point within the fuel filter assembly where the water level is undesirable. When water is not in contact with both electrical conductors, the electrical circuit between the indicator and the water sensor is open. Because fuel does not conduct electricity, the electrical circuit will remain open even if fuel makes contact with both electrical conductors. However, when the water makes contact with both electrical conductors, the water completes the electrical circuit between the water sensor and the indicator, causing the indicator to alert the operator that the water is at the undesirable level.

Although the electric water sensor can determine and alert the operator of the water level within the fuel filter assembly, in order to install the water sensor within the water collection bowl, holes are drilled through the housing of the fuel filter assembly. Thus, installation of the water sensor in the fuel filter assembly may increase the manufacturing costs of the fuel filter assembly. Also, the fact that holes must be drilled through the housing may make it difficult to design a fuel filter assembly specifically to meet the needs of a purchaser. For instance, different fuel filter assembly housings must be manufactured for customers desiring the water sensor and indicator and for customers not desiring the water sensor. Further, the holes drilled through the housing may increase the potential for leakage from the fuel filter assembly.

The present invention is directed to overcoming one or more of the problems set forth above.

### SUMMARY OF THE INVENTION

In one aspect of the present invention, a fuel filter assembly includes a housing including a drain opening. A water drain assembly is positioned within the drain opening. A water sensor includes a first portion that is positioned within the housing, a second portion that is positioned outside the housing, and a third portion that is, at least partially, positioned within the water drain assembly and connects the first portion with the second portion.

In another aspect of the present invention, a fuel system includes a water collection housing that includes a drain opening. A water drain assembly is positioned within the drain opening. A water sensor includes a first portion that is positioned within the water collection housing, a second portion that is positioned outside the water collection housing, and a third portion that is, at least partially, positioned within the water drain assembly and connects the first portion with the second portion.

In yet another aspect of the present invention, a method of installing a water sensor in a fuel system includes a step of positioning a first portion of the water sensor inside a water collection housing. A second portion of the water sensor is exposed outside the water collection housing. A third portion of the water sensor connects the first position and the second portion of the water sensor, at least in part, by being positioned within a water drain assembly attached to the water collection housing.

### BRIEF DESCRIPTION OF THE DRAWINGS

FIG. 1 is a schematic representation of a fuel system, according to the present invention;

FIG. 2 is a sectioned side view of a fuel filter assembly of the fuel system of FIG. 1, according to a first embodiment of the present invention;

FIG. 3 is a sectioned side view of a water sensor included in the fuel filter assembly of FIG. 2; and

FIG. 4 is a sectioned side view of a water sensor included in a fuel filter assembly, according to an alternative embodiment of the present invention.

### DETAILED DESCRIPTION

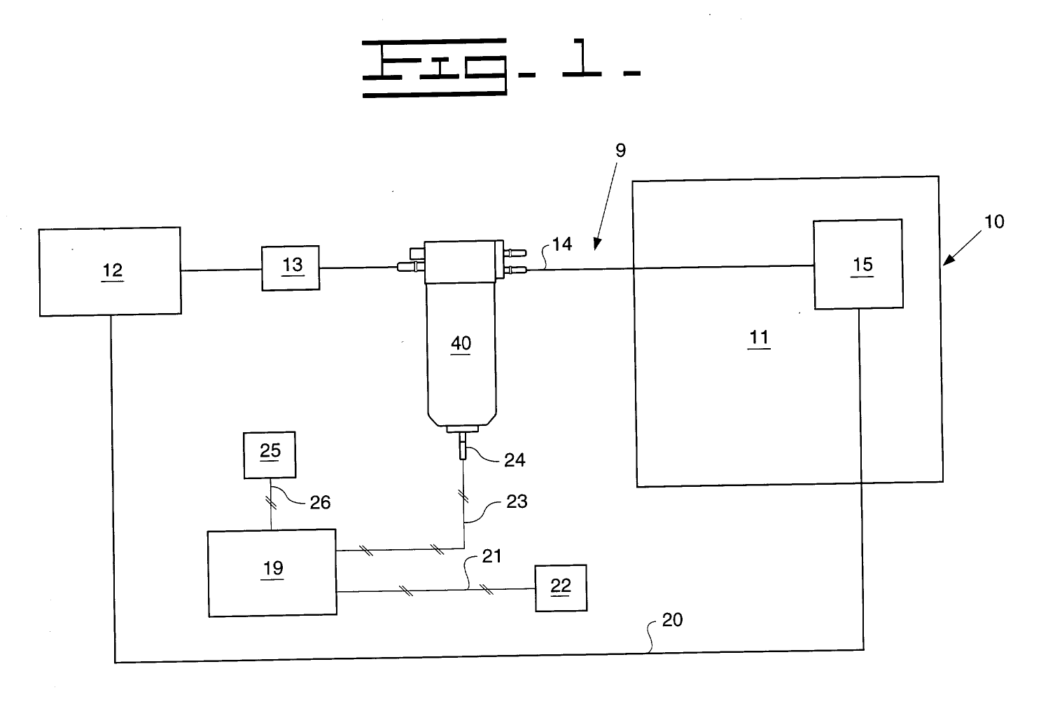

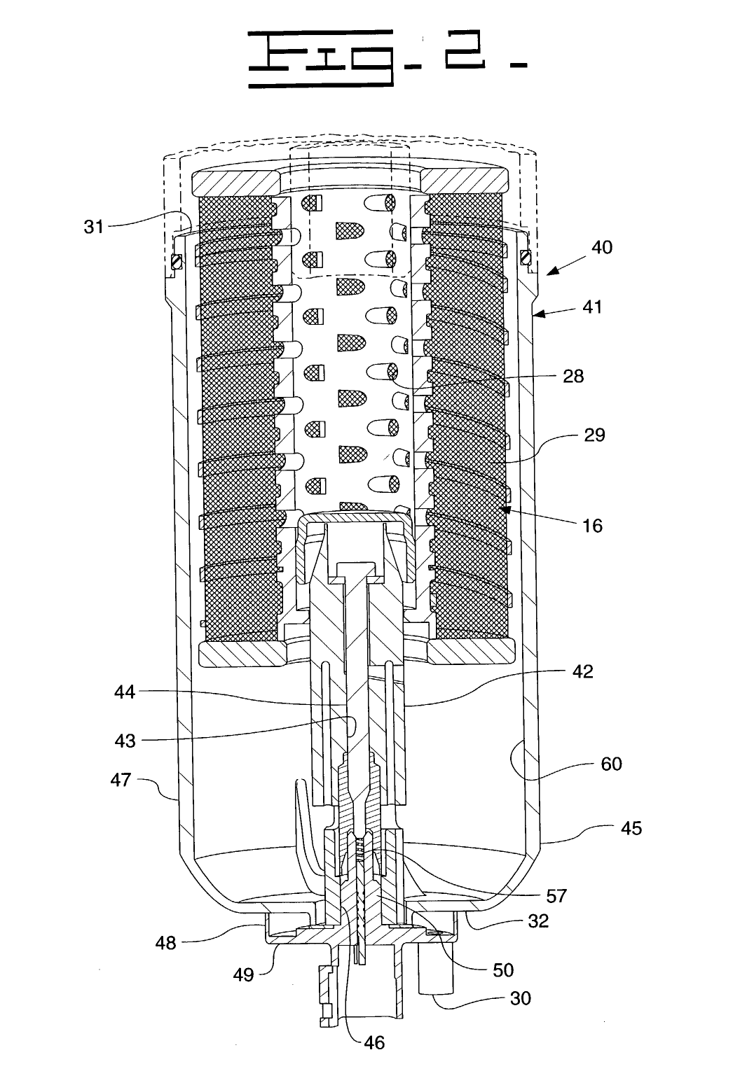

Referring to FIG. 1, there is shown a schematic representation of a fuel system 9, according to the present invention. An engine 10 includes an engine housing 11 to which the fuel system 9 is attached. A fuel tank 12 is provided within the fuel system 9 and is in fluid communication with a supply line 14 and a fuel return line 20. A fuel filter assembly 40 is included within the fuel system 9 and is positioned in the supply line 14. It should be appreciated that the fuel filter assembly 40 may be attached to the engine housing 11 or the body of the vehicle or machinery. Further, it should be appreciated that the fuel system 9 could include more than one fuel filter assembly. The fuel filter assembly 40 preferably includes a fuel filter 16 (shown in FIG. 2) that acts to trap precipitates and other solids from fuel flowing through the supply line 14, and to separate water from the fuel. Due to its specific gravity, the water within the fuel separates and collects at the bottom of the fuel filter assembly 40. Although the fuel filter both cleans the fuel and separates water from the fuel, the present invention also contemplates a fuel system that includes a water separator that is separate from a fuel filter. Thus, it should be appreciated that the water separator could be included in a separate housing than the fuel filter. A fuel transfer pump 13 is positioned within the supply line 14 to draw low pressure fuel out of the fuel tank 12 and to circulate the fuel through the fuel filter assembly 40 and to at least one fuel injector 15 provided within the engine 10. Although the fuel transfer pump 13 is illustrated as separate from the fuel filter assembly 40, it should be appreciated that the fuel transfer pump 13 could be included within the same housing as the fuel filter assembly 40. While the present invention is described for one fuel injector 15, it should be appreciated that the present invention is applicable to an engine housing any desired number of fuel injectors 15. The fuel injector 15 is in fluid communication with the supply line 14 and the return line 20.

An electronic control module 19 is in communication with the fuel filter assembly 40 via a water collection communication line 23 and with an indicator 22 via an indicator communication line 21. The water collection communication line 23 preferably includes at least two communication wires in one insulative casing. One wire delivers the incoming electric current to the fuel filter assembly 40 from the electronic control module 19, and the other delivers the outgoing electric current from the fuel filter assembly 40 to the electronic control module 19. Each wire is in communication with a different female connector included within an electrical socket 24. The electrical socket 24 is attached to the water collection communication line 23 and connects the fuel filter assembly 40 to the water collection communication line 23. Although the fuel filter assembly 40 is in communication with the indicator 22 via the electronic control module 19, it should be appreciated that the fuel filter assembly 40 could be in direct communication with to the indicator 22. Although the indicator 22 is preferably a visual or audio cue within an operator station that alerts an operator when water separated from the fuel within the fuel filter assembly 40 reaches a predetermined level, it should be appreciate that the indicator 22 could be any type of cue positioned at any point within the vehicle or machinery which would alert the operator that the water has reached the predetermined level. The predetermined level of water is the level of water at which the operator should drain the water from the fuel filter assembly 40 in order to avoid the re-mixing of the separated water with the fuel. In addition, an automatic water drain using emerging technologies triggered by the sensor are also contemplated, and might be desirable. The electronic control module 19 is in communication with a power source 25 via a power communication line 26. However, it should be appreciated that the fuel filter assembly 40 could be in direct communication with the power source 25. It should further be appreciated that the power source 26 could be any type of power-generating source, including, but not limited to, a battery.

Referring to FIG. 2, there is shown sectioned side view of the fuel filer assembly 40 of FIG. 1, according to a first embodiment of the present invention. The fuel filter assembly 40 includes a housing 41 in which the fuel filter 16 is positioned. The housing 41 includes an open end 31 and a closed end 32. The fuel filter 16 includes a filter element 29 that defines a central passage 28. A disc lock 42 is positioned between the fuel filter 16 and the housing 41, and defines a bore 43 in which a bolt 44 is positioned. The disc lock 42 is preferably secured to the housing 41 via the bolt 44, and the fuel filter 16 is preferably attached to the disc lock 42 such that the fuel filter 16 is securely positioned adjacent to the open end 31 of the housing 41, leaving a water collection bowl 60 below the fuel filter 16. The fuel filter 16 could be attached to the disc lock 43 by various methods, including but not limited to, mating a threaded portion of the disc lock 42 to a portion of the fuel filter 16. The fuel filter 16 could also be biased to the open end 31 of the housing by other means known in the art, such as a spring. The housing 41 includes a water collection housing 45 that includes a water drain opening 46. The water collection housing 45 has an annular outer surface 47 that is preferably cylindrical. Due to its specific gravity, water collects in the water collection bowl 60, being the bottom cupped-shaped area defined by the water collection housing 45, as fuel is circulated through the fuel filter 16.

A water drain assembly 48 is positioned within the water drain opening 46. The water drain assembly 48 preferably includes a disc 49 and an attachment portion 50, and defines an outlet 30. The water drain assembly 48 is preferably moveable between three positions: a first position (as shown in FIG. 2) in which the water drain assembly 48 is secured to the housing 41, a second position in which the water drain assembly 48 is detached from the housing 41, and a third position which is a middle position between the first position and the second position. When the water drain assembly 48 is in the first position, the drain opening 46 is closed. When the water drain assembly 48 is in the second position, the drain opening 46 is open, and when the water drain assembly 48 is in the third position, the drain opening 46 is in fluid communication with the outlet 30. At least one of the inner surface of the drain opening 46 and the attachment portion 50 of the water drain assembly 48 is preferably threaded. Although the water drain assembly 48 is attached to the housing 41 via the threaded portion, it should be appreciated that the water drain assembly 48 could be attached to the housing 41 by any means known in the art. In the first embodiment illustrated in FIG. 2, a spring 57 is positioned within the water drain assembly 48 such that it is compressed between the bolt 44 and the water drain assembly 48, when the water drain assembly 48 is attached to the water collection housing 45.

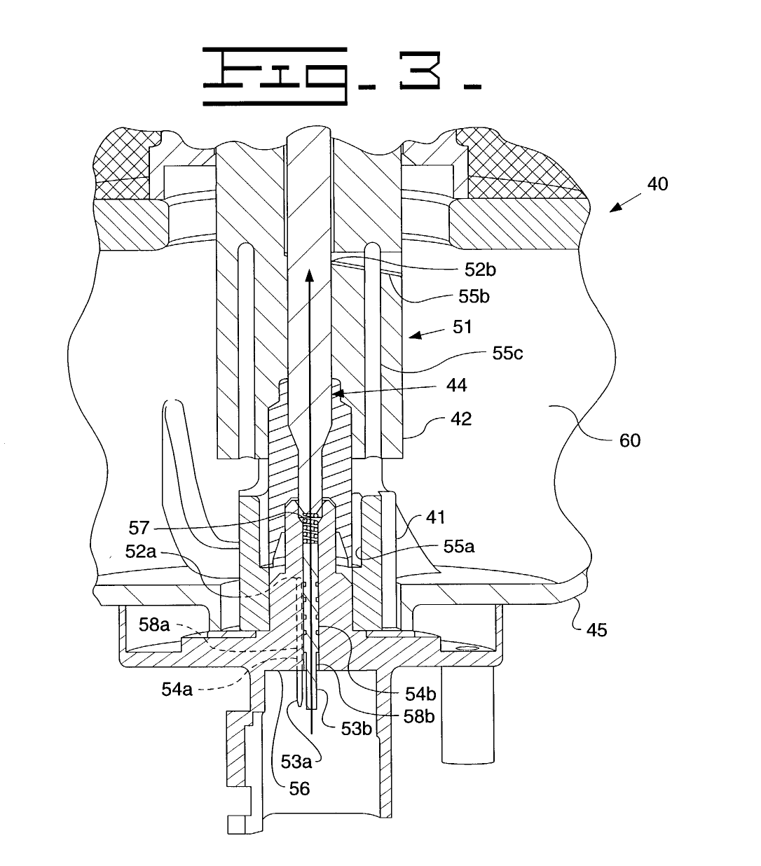

Referring to FIG. 3, there is shown a sectioned side view of a water sensor 51 included within the fuel filter assembly 40 of FIG. 2. The water sensor 51 is included within the fuel filter assembly 40. The water sensor 51 includes a first portion 52 that is positioned within the water collection housing 45. The first portion 52 preferably includes a first electrically conductive water contact 52a and a second electrically conductive water contact 52b. The first electrically conductive water contact 52a is preferably included within a first rod 58a, and the second electrically conductive water contact 52b is preferably includes the bolt 44. The first electrically conductive water contact 52a is preferably exposed in a first water passage 55a and the second electrically conductive water contact 52b is preferably exposed in a second water passage 55b. The second water passage 55b and the second electrically conductive water contact 52b are positioned at the height within the water collection bowl 60 where the water level has reached the predetermined level. The predetermined level is the level at which the water within the fuel filter assembly 40 may begin re-mixing with the fuel, and thus, should be drained. Although the first water passage 55a and the first electrically conductive water contact 52a could be positioned at various heights within the water collection bowl 60, the first water passage 55a and the first electrically conductive water contact 52a should be positioned at a height lower or equivalent to the height of the second water contact 55b. The first water passage 55a is illustrated as defined by the housing 41 and being at least partially included in the drain opening 46. The second water passage 55b is illustrated as defined by the disc lock 42. The second water passage 55b is angled downward towards the drain opening 46 in order to assure that all of the water is drained via the water drain assembly 48, rather than a portion seeping into the bore 43. Both the first water passage 55a and the second water passage 55b are in fluid communication with the water collection bowl 60 and a connecting water passage 55c. The water sensor 51 includes a second portion that is positioned outside the water collection housing 45. The second portion preferably includes a first electrical lead 53a and a second electrical lead 53b. The first electrical lead 53a and the second electrical lead 53b extend through a bottom surface 56 of the water drain assembly 48. The first electrical lead 53a and the second electrical lead 53a are arranged and shaped such that they mate with female connectors of the electrical socket 24 (shown in FIG. 1) in a conventional manner.

Referring still to FIG. 3, the water sensor 51 includes a third portion that is positioned within the water drain assembly 48 and connects the first portion of the water sensor 51 with the second portion of the water sensor 51. The third portion preferably includes the first electrical connector 54a and a second electrical connector 54b. The first electrical connector 54a and the second electrical connector 54b are preferably embedded in the water drain assembly 48 and, along with the first electrical lead 53a and the second electrical lead 53b, are preferably comprised of a suitable conductor, such as either aluminum and stainless steel. Further, the first electrical lead 53a, the first electrical connector 54a and the first electrically conductive water contact 52a are included in the first rod 58a are preferably comprised of a suitable conductor, such as either aluminum or stainless steel. The second electrical lead 53b and the second electrical connector 54b are included in a second rod 58b also comprised of a suitable conductor, such as either aluminum or stainless steel. In addition to the electrical connectors 54a and 54b, the third portion of the water sensor 51 preferably includes at least one fuel filter assembly component that is electrically conductive. According to the first embodiment illustrated in FIG. 2, the bolt 44 and the spring 57 are preferably fuel filter assembly components included within the third portion 54 of the water sensor 51.

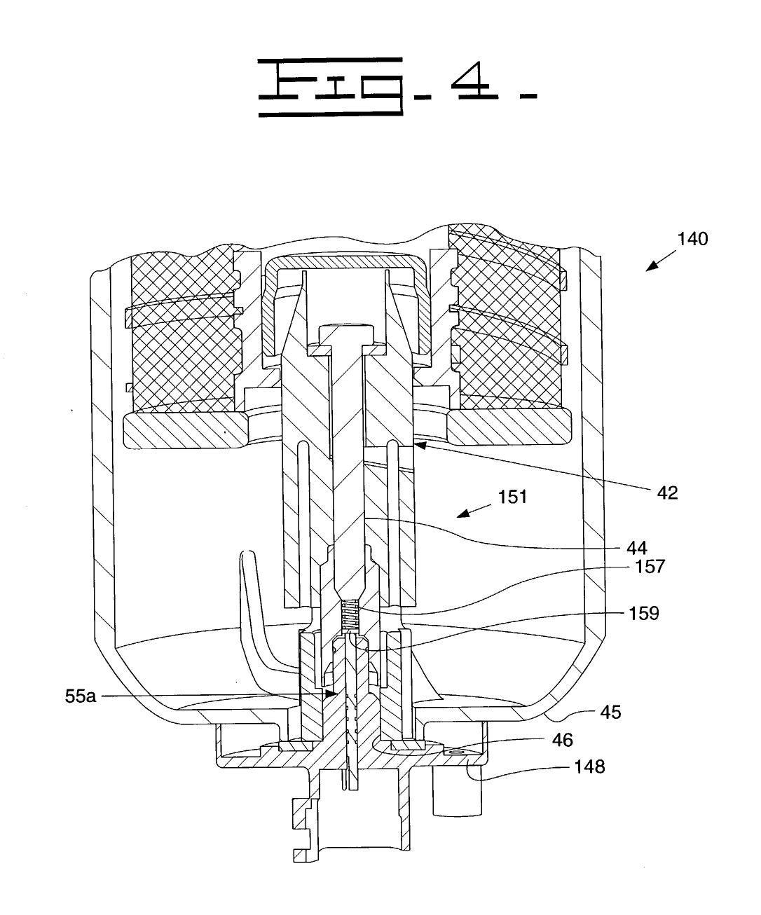

Referring to FIG. 4, there is shown a sectioned side view of a water sensor 151 included in a fuel filter assembly 140, according to an alternative embodiment of the present invention. Similar to the first embodiment, a water drain assembly 148 is included within the water drain opening 46 defined by the water collection housing 45. However, unlike the first embodiment, a spring 157 is positioned between the water drain assembly 148 and the bolt 44, rather than included within the water drain assembly 148. Further, a washer 159 is positioned between the spring 157 and the water drain assembly 148. The washer 159 prevents water within the first passage 55a from making contact with the spring 157 and a bolt 44. In both embodiments, the spring 57,157 and bolt 44 are preferably electrically conductive.

### INDUSTRIAL APPLICABILITY

Referring to FIGS. 1 through 4, although the application of the present invention is described for the first embodiment of the present invention, it should be appreciated that the present invention operates similarly for both embodiments of the invention. Further, although the present invention is described for the fuel filter assembly 40 that separates fuel from both water and particulates, it should be appreciated that the present invention is applicable to any fuel system in which water is separated from fuel prior to the injection of the fuel into the engine, regardless of whether the water is separated from the fuel within the fuel filter assembly.

In order to install the water sensor 51 into the fuel filter assembly 40, the first electrical lead 53a, the second electrical lead 53b, the first electrical connector 54a, and the second electrical connector 54b are attached to the water drain assembly 48. Although the first electrical lead 53a and the first electrical connector 54a could be two separate components, each comprised of an electrically conductive material in contact with one another 53a and 54a, the present invention illustrates the first electrical lead 53a and the first electrical connector 54a being included in the first rod 58a. Similarly, the second electrical lead 53b and the second electrical connector 54b are preferably included in the second rod 58b. Although the rods 58a and 58b could be comprised of various electrically conductive materials, both the rods 58a and 58b are preferably comprised of aluminum and/or stainless steel. Prior to attaching the water drain assembly 48 to the housing 41, the rods 58a and 58b are preferably embedded into the water drain assembly 48. The water drain assembly 48 is comprised of an insulative material, such as plastic. During assembly of the water drain assembly 48, the rods 58a and 58b are arranged and embedded into the insulative material such that the electrical leads 53a and 53b extend through the bottom surface 56 of the water drain assembly 48 and can mate with female connectors of the electrical socket 24. This can be accomplished, for example, by known plastic molding techniques.

After the water drain assembly 48 is assembled including the rods 58a and 58b, the water drain assembly 48 is preferably mated to the housing 41 via the threaded portion of one the housing 41 and the water drain assembly 48. As the installer rotates the water drain assembly 48 into water drain opening 46, the spring 57 positioned within the water drain assembly 48 begins to compress between the second electrical connector 54b embedded within the water drain assembly 48 and the bolt 44. In the alternative embodiment illustrated in FIG. 4, the spring 157 compresses between the electrically conductive washer 159 and the bolt 144. When the water drain assembly 48 is the first position in which it is securely attached to the housing 41, the spring 57, 157 is sufficiently compressed to establish an electrical connection between the second electrical connector 54b and the bolt 44, 144. Once the water drain assembly 48 is attached to the fuel filter assembly 40, the electrical leads 53a and 53b extending through the bottom 56 of the water drain assembly 48 are exposed outside the housing 41 and are mated to the female connectors included in the socket 24, establishing an electrical connection between the water sensor 51 and the water collection communication line 23. Thus, the water sensor 51 is in communication with the power source 25 via the water collection communication line 23, the electronic control module 19 and the power source communication line 26. However, until water makes contact with both the first electrically conductive water contact 52a and the second electrically conductive water contact 52b, an electrical circuit including the power source 25, the water sensor 51 and the indicator 22 is open, preventing electric current from being provided to the indicator 22.

Once the water sensor 51 is installed and the operator activates the ignition, the fuel transfer pump 13 begins pumping fuel from the fuel tank 12 through the supply line 14. Before being delivered to the fuel injector 15 for injection into the engine 10, the fuel is pumped through the fuel filter assembly 40 in order to trap particulates and solids from the fuel, and to separate water from the fuel. As the fuel is delivered through the filter element 29, particulates and solids will be trapped by the filter element 29. Further, due to its specific gravity, water will fall to the water collection bowl 60 located at the bottom of the fuel filter assembly 40. The cleaned fuel will flow from the filter element 29 to supply line 14 via the center passage 28 of the fuel filter assembly 40. Although the flow of fuel through the fuel filter 16 is illustrated as flowing inward from the housing 41 toward the center passage 28, it should be appreciated that the present invention operates similarly in a fuel filter assembly in which the fuel flows from the center passage 28 outwards towards the housing 41. The cleaned fuel can then be delivered to the fuel injector 15 in order to be injected in to the engine 10. The fuel that is not injected in the engine 10 will be delivered back to the fuel tank 12 via the return line 20 for re-circulation within the fuel system 9.

As the engine 10 operates, the fuel filter 16 is continually separating water from the fuel passing through the fuel filter assembly 40. The level of the water being collected in the water collection bowl 60 continues to rise. Eventually, the water level will reach the height of the first water passage 55a. It should be appreciated that the first water passage 55a could be positioned at any height within the water collection bowl 60, as long as the water level will reach the first water passage 55a prior to or at the same time as reaching the second water passage 55b. The water will flow from the water collection bowl 60 and into the first water passage 55a, in which the water will make contact with the first electrically conductive water contact 52a. Although the first electrically conductive water contact 52a is an exposed portion of the first electrical connector 54a, it should be appreciated that the first electrically conductive water contact 52a could be included in any fuel filter assembly component comprised of an electrically conductive material and in electrical communication with the first electrical lead 53a.

The water will continue to rise until it reaches the second water passage 55b. The water will flow from the water collection bowl 60 to the second water passage 55b, in which the water will contact a surface of the bolt 44, acting as the second electrically conductive water contact 52b. The second water passage 55b and the second electrical contact 52b are positioned at the height within the water collection bowl 60 where the water level has reached the predetermined level. The predetermined water level is the level at which the water within the fuel filter assembly 40 may begin re-mixing with the fuel, and thus, should be drained. Once the water makes contact with the second electrically conductive water contact 52b, an electrical circuit is completed. Electrical energy created by the power source 25 can flow to the fuel filter assembly 40 via the power communication line 26, the electronic control module 19 and the water collection communication line 23. Because the first electrical lead 53a and the second electrical lead 53b are mated to the socket 24 attached to the water collection communication line 23, electric current can flow from the incoming wire of the water collection communication line 23 to the second electrical lead 53b. As the arrow in FIG. 3 illustrates, the electric current will flow through the electrical lead 53b extending through the bottom 56 of the water drain assembly 48 and through the second electrical connector 54b. The electric current will then travel through the spring 57 and the bolt 44 in order to reach the second electrical contact 52b. However, in the alternative embodiment, the electric current will also travel through the washer 159 positioned between the water drain assembly 140 and the spring 157.

Because the water is in contact with the second electrically conductive water contact 52b included within the bolt 44 and water is electrically conductive, the electric current can then flow from the bolt 44 through the water within the second water passage 55b and the first water passage 55a. The electric current will then flow from the first electrically conductive water contact 52a to the first electrical lead 53a that extends through the bottom 56 of the water drain assembly 48 via the first electrical connector 54a. The current flows through the socket 24 to the outgoing wire in communication with one of the female conductors of the electrical socket 24 and included within the water collection communication line 23. The water collection communication line 23 will direct current to the electronic control module 19, which will send the electric current to the indicator 22 via the indicator communication line 21. Because the water completes the electrical circuit between the power source 25 and the indicator 22, the electric current will reach the indicator 22 only when water is in contact with both electrically conductive water contacts 52a and 52b of the water sensor 51. It should be appreciated that even if fuel makes contact with both electrically conductive contacts 52a and 52b, the electrical circuit will remain open because fuel is not electrically conductive. The energized indicator 22 will alert the operator that the water level has reach the predetermined water level, thereby requiring the operator to drain the water.

Those skilled in the art should appreciate that although the flow of electric current has been described as flowing to the water sensor 51 via the second electrical lead 53b and away from the water sensor 51 via the first electrical lead 53a, the present invention contemplates the flow of the electric current flowing in the opposite direction also. Further, it should be appreciated that although the bolt 44, 144, the spring 57, 157, and the washer 159 function as electrical conductors within the water sensor 51, the present invention contemplates a water sensor without the use of fuel filter assembly components.

Once the indicator 22 alerts the operator that the water has reached the predetermined water level, the operator may, upon de-activation of the ignition, drain the water from the fuel filter assembly 40 by, at least in part, by moving the water drain assembly 48 from the first position, in which it is secured to the housing 41, to the third position. In order to move the water drain assembly 48 to the third position, the operator may rotate the water drain assembly 48 in a first direction to a predetermined angle. The predetermined angle of rotation is the angle that will sufficiently open the drain opening 46 in order to allow the water to drain from the fuel filter assembly 40 through the outlet 30, but not loosen the water drain assembly 48 to the point where the water drain assembly 48 is in the second position, being detached from the housing 41. Although the water is drained from the illustrated fuel filter assembly 40 through the drain opening 46 by rotating the water drain assembly 48, it should be appreciated that the water could be drained via the water drain assembly 48 by various methods, including but not limited to, moving a valve positioned within a passage of the water drain assembly 48 to an open position. When the draining of the water is completed, the water drain assembly 48 can be again secured to the housing 41.

The present invention is advantageous because, rather than relying on the operator's diligence to inspect the water level within the fuel filter assembly 40, the water sensor 51 automatically alerts the operator when the water within the fuel filter assembly 48 is at a level where it is desirable to drain the water. Moreover, the present invention is advantageous because it positions, at least in part, the water sensor 51 within the water drain assembly 48 that is detachable from the housing 41 of the fuel filter assembly 40. Because the water sensor 51 can be installed along with the water drain assembly 48, there is no need to drill holes in the housing 41 of the fuel filter assembly 48 when installing the water sensor 51. Because additional holes are not drilled within the housing 41, the potential for leakage and manufacturing costs may be reduced. Further, the fact that at least a portion of the water sensor 51 is included in the detachable water drain assembly 48 gives the purchaser the option of purchasing a fuel filter assembly without the indicator. The assembly of a fuel filter assembly will be similar regardless of whether the customer desires the water level indicator 22. In order to assemble a fuel filter assembly without the water sensor 51, a water drain assembly without the rods 58a and 58b will be mated to the housing 41.

In addition, the present invention is advantageous because it utilizes fuel filter assembly components that already have a function within the fuel filter assembly 40 as electrical conductors. For instance, in both embodiments, the bolt 44, 144 and the spring 57, 157 are included within the fuel filter assembly 40 in order to secure the filter 16 to the housing 41. Because the bolt 44, 144 and the spring 57, 157 are comprised of electrically conductive materials and positioned within the water collection bowl 60 between the fuel filter 16 and the water drain assembly 48, the bolt 44, 144 and spring 57, 157 can also serve a second function of conducting electric current between the second electrically conductive water contact 52b and the second electrical connector 54b. This is particularly important when the predetermined water level at which the operator is alerted is a substantial distance from the water drain assembly 48. Thus, the electrically conductive water contact 52b can be positioned at a height corresponding to the predetermined water level without installing additional electrical connectors into the fuel filter assembly 40, thereby reducing the number of components and the robustness of the system.

It should be understood that the above description is intended for illustrative purposes only, and is not intended to limit the scope of the present invention in any way. Thus, those skilled in the art will appreciate that other aspects, objects, and advantages of the invention can be obtained from a study of the drawings, the disclosure and the appended claims.

What is claimed is:

1. A fuel filter assembly comprising:
a housing including a drain opening;
a water drain assembly being positioned within the drain opening; and
a water sensor including a first portion being positioned within the housing, a second portion being positioned outside of the housing, and a third portion being, at least partially, positioned within the water drain assembly and connecting the first portion with the second portion.

2. The fuel filter assembly of claim 1 wherein the first portion of the water sensor includes a first electrically conductive water contact and a second electrically conductive water contact; the second portion of the water sensor includes a first electrical lead and a second electrical lead; and the third portion of the water sensor includes a first electrical connector and a second electrical connector.

3. The fuel filter assembly of claim 2 wherein the first electrical lead and the second electrical lead extend through a bottom surface of the water drain assembly.

4. The fuel filter assembly of claim 2 wherein the third portion of the water sensor includes at least one fuel filter assembly component; and
the at least one fuel filter assembly component being electrically conductive.

5. The fuel filer assembly of claim 4 wherein the fuel filter assembly component includes at least one of a bolt, a spring and a washer.

6. The fuel filter assembly of claim 5 wherein the spring being included in the water drain assembly.

7. The fuel filter assembly of claim 1 wherein the water drain assembly being moveable between a first position, a second position, and a third position;
when the water drain assembly is in the first position, the water drain assembly is secured to the housing, and when the water drain assembly is in the second position, the water drain assembly is detached from the housing; and
the third position being a middle position between the first position and the second position.

8. The fuel filter assembly of claim 5 wherein the first electrical lead and the second electrical lead extend through a bottom surface of the water drain assembly;
the first electrical connector, the second electrical connector, the first electrical lead and the second electrical lead being comprised of a material including at least one of aluminum and stainless steel; and
the water drain assembly being moveable between a first position in which the water drain assembly is secured to the housing, a second position in which the water drain assembly is detached from the housing, and a third position being a middle position between the first position and the second position.

9. A fuel system comprising:
a water collection housing including a drain opening;
a water drain assembly being included within the drain opening; and
a water sensor including a first portion being positioned within the water collection housing, a second portion being positioned outside of the water collection housing; and a third portion being, at least partially, positioned within the water drain assembly and connecting the first portion with the second portion.

10. The fuel system of claim 9 wherein the water collection housing being included in a fuel filter assembly.

11. The fuel system of claim 10 wherein the water drain assembly includes a first position, a second position, and a third position;
when the water drain assembly is in the first position, the water drain assembly being secured to the water collection housing, and when the water drain assembly is in the second position, the water drain assembly being detached from the water collection housing; and
the third position being a middle position between the first position and the second position.

12. The fuel system of claim 11 wherein the first portion of the water sensor includes a first electrically conductive water contact and a second electrically conductive water contact; the second portion of the water sensor includes a first electrical lead and a second electrical lead; and the third portion of the water sensor includes a first electrical connector and a second electrical connector.

13. The fuel system of claim 12 wherein the second portion of the water sensor includes at least one fuel filter assembly component; and
the at least one fuel filter assembly component being electrically conductive.

14. The fuel system of claim 13 wherein the first electrical lead and the second electrical lead mate with an electrical socket; and
the electrical socket being in communication with a water level indicator and a power source via at least one communication line.

15. The fuel system of claim 14 wherein the water level indicator being positioned within an operator station and including at least one of an audio cue and a visual cue.

16. A method of installing a water sensor in a fuel system comprising the steps of:
positioning a first portion of the water sensor inside a water collection housing;
exposing a second portion of the water sensor outside the water collection housing; and
connecting the first portion and the second portion of the water sensor, at least in part, by positioning a third portion of the water sensor in a water drain assembly attached to the water collection housing.

17. The method of claim 16 wherein the step of positioning includes a step of embedding a first electrical connector and a second electrical connector in the water drain assembly.

18. The method of claim 16 wherein the step of connecting includes a step of integrating at least one fuel filter assembly component into the third portion of the water sensor.

19. The method of claim 16 including a step of connecting a third portion of the water sensor to the a water level indicator.

20. The method of claim 19 wherein the connecting step includes a step of shaping the third portion of the water sensor to mate with an electrical socket.
